(19) United States
(12) Patent Application Publication
(10) Pub. No.: US 2016/0101867 A1
(43) Pub. Date: Apr. 14, 2016

(54) AIRCREW SEAT

(71) Applicant: Gulfstream Aerospace Corporation, Savannah, GA (US)

(72) Inventors: Patrick McLaughlin, Savannah, GA (US); Jeremy Hanson, Savannah, GA (US)

(21) Appl. No.: 14/860,254

(22) Filed: Sep. 21, 2015

Related U.S. Application Data
(60) Provisional application No. 62/063,377, filed on Oct. 13, 2014.

(51) Int. Cl. B64D 11/06

(52) U.S. Cl. CPC B64D 11/0644; B64D 11/0689

(57) ABSTRACT

An aircrew seat for use in a flight deck includes, but is not limited to, a seat assembly that includes a seat back. The seat assembly is configured to be mounted in the flight deck. The aircrew seat further includes, but is not limited to, an armrest that is mounted to a side of the seat back. An end of the armrest is configured to move fore and aft between an extended position and a retracted position.

### CROSS-REFERENCE TO RELATED APPLICATIONS

This application claims the benefit of co-pending U.S. Provisional Patent Application 62/063,377, filed on 13 Oct., 2014 and entitled “Crew Seat With Retractable Armrest,” which is hereby incorporated herein by reference in its entirety.

### TECHNICAL FIELD

The present invention generally relates to aircraft and more particularly relates to aircrew seats.

### BACKGROUND

Conventional aircrew seats are configured for use onboard aircraft having a yoke. The yoke is commonly positioned directly in front of a conventional aircrew seat and rests between the legs of the aircrew member seated in front of it. The aircrew member seated in the conventional aircrew seat places both of his or her hands on the steering wheel portion of the yoke when actively flying the aircraft. When not actively flying the aircraft, the aircrew member commonly rests his or her elbows on the armrests of the conventional aircrew seat. The armrests on conventional aircrew seats do not extend or retract, but can be stowed (e.g., pivoted upward to a position behind the seat back) if needed or desired. When using a conventional seat with a yoke, the armrests do not create an unacceptable interference with the yoke while they are in their operational position (i.e., positioned to support the arms of the aircrew member.

Some modern aircraft have abandoned the traditional yoke in favor of the side stick controller. Side stick controllers are mounted at an outboard portion of a flight deck (e.g., console, pedestal, cabinet, side portion of instrument panel) and allow the aircrew member to control the aircraft with one hand. A port side stick controller will be mounted somewhere along the port side (left side when facing forward) of the flight deck while a starboard side stick controller will be mounted somewhere along the starboard side (right side when facing forward) of the flight deck, one each for the pilot and the co-pilot.

Side stick controllers are typically positioned at a height that permits the aircrew member to comfortably engage the side stick controller from a seated position. To facilitate an aircrew member's ability to use the side stick controller, a stationary armrest is commonly mounted to the same surface as the side stick controller at a location just aft of the side stick controller. This stationary armrest permits an aircrew member to rest his or her forearm or wrist while providing inputs into the side stick controller.

If a conventional aircrew seat were employed in an aircraft that employs a side stick controller, the possibility exists that the outboard armrest may make physical contact with the stationary armrest or, in some cases, with the side stick controller itself. Such contact would be undesirable.

It is desirable to provide an aircrew seat that addresses the above described situation. Furthermore, other desirable features and characteristics will become apparent from the subsequent summary and detailed description and the appended claims, taken in conjunction with the accompanying drawings and the foregoing technical field and background.

### BRIEF SUMMARY

An aircrew seat for use in a flight deck is disclosed herein.

In a first non-limiting embodiment, the aircrew seat includes, but is not limited to, a seat assembly including a seat back. The seat assembly is configured to be mounted in a flight deck. The aircrew seat further includes, but is not limited to, an armrest that is mounted to a side of the seat back. An end of the armrest is configured to move fore and aft between an extended position and a retracted position.

In another non-limiting embodiment, the aircrew seat includes, but is not limited to, a seat assembly including a seat back. The seat assembly is configured to be mounted in the flight deck proximate a side stick controller. The aircrew seat further includes, but is not limited to, an armrest that is mounted to a side of the seat back proximate the side stick controller. The arm rest comprises a first section and a second section. The first section is coupled to the seat back. The second section is telescopically coupled to the first section. The second section is configured to move fore and aft between an extended position and a retracted position. The second section is further configured to move aft toward the retracted position in response to an aft directed push applied to the second section.

### BRIEF DESCRIPTION OF THE DRAWINGS

The present invention will hereinafter be described in conjunction with the following drawing figures, wherein like numerals denote like elements, and

FIG. 1 is a perspective view illustrating a flight deck equipped with a non-limiting embodiment of an aircrew seat of the present disclosure, an armrest of the aircrew seat being disposed in an extended position;

FIG. 2 is a perspective view illustrating the flight deck and aircrew seat of FIG. 1 with the armrest of the aircrew seat being disposed in a retracted position;

FIG. 3 is a perspective view illustrating a first section of a non-limiting embodiment of an armrest of the aircrew seat of FIG. 1;

FIG. 4 is a perspective view illustrating a second section of a non-limiting embodiment of the armrest of the aircrew seat of FIG. 1; and

FIG. 5 is an axial view illustrating engagement between the first section of FIG. 3 and the second section of FIG. 4.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved aircrew seat that is compatible for use in flight decks equipped with side stick controllers is disclosed herein. In a non-limiting embodiment, the aircrew seat includes an outboard armrest having an end that can be extended when the aircrew seat is spaced apart from any obstructions and that can be retracted when the aircrew seat encounters obstructions. In some embodiments, the outboard armrest may comprise two sections that are telescopically engaged with one another. In other embodiments, the entire armrest may translate in order to extend and retract from the seat back of the aircrew seat. In other embodiments, any other mechanism that permits the forward or leading end of the armrest to translate or extend/retract between an extended position and a retracted position may be employed without departing from the teachings disclosed herein. When the aircrew seat is moved forward along seat rails or otherwise through the flight deck, if the outboard armrest encounters an obstruction, the outboard armrest is configured to retract rather than to impart a pushing force on the obstruction.

A greater understanding of the flight deck arrangement described above may be obtained through a review of the illustrations accompanying this application together with a review of the detailed description that follows.

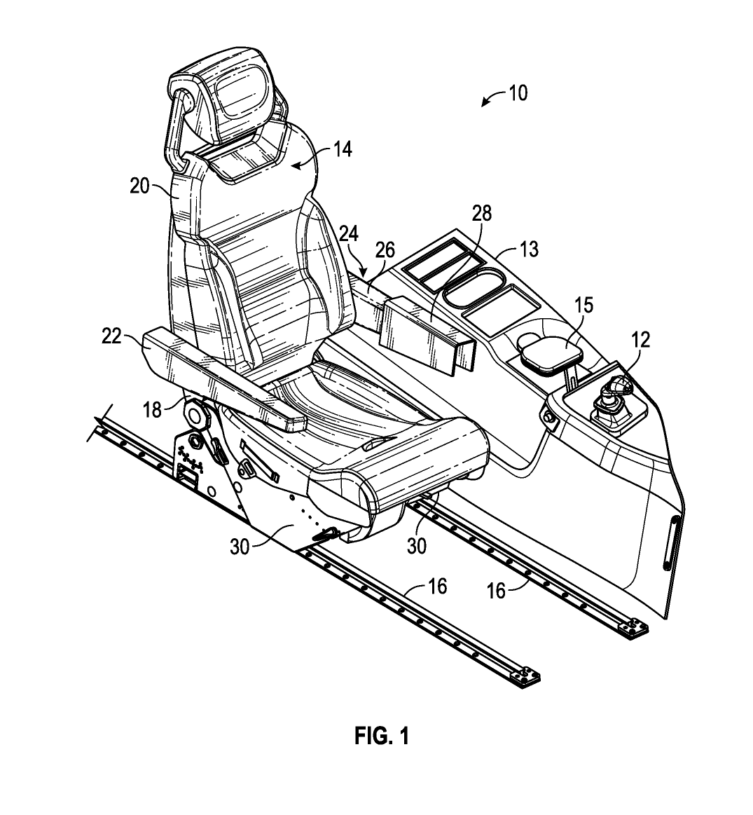

FIG. 1 is perspective view illustrating a portion of a flight deck 10 of a modern aircraft. Flight deck 10 is equipped with a side stick controller 12 mounted on a port side console 13. Flight deck 10 also includes a second side stick controller mounted on a starboard side console (not shown). In the illustrated embodiment, port side console 13 and the starboard side console (not shown) curve inwardly at the front portion of flight deck 10 and join with an instrument panel (not shown).

A stationary armrest 15 is mounted to port side console 13 at a position just aft of side stick controller 12. Stationary armrest 15 provides a convenient resting place for an aircrew member's forearm or wrist when holding side stick controller 12. A second stationary armrest is mounted to the starboard side console just aft of the starboard side stick controller.

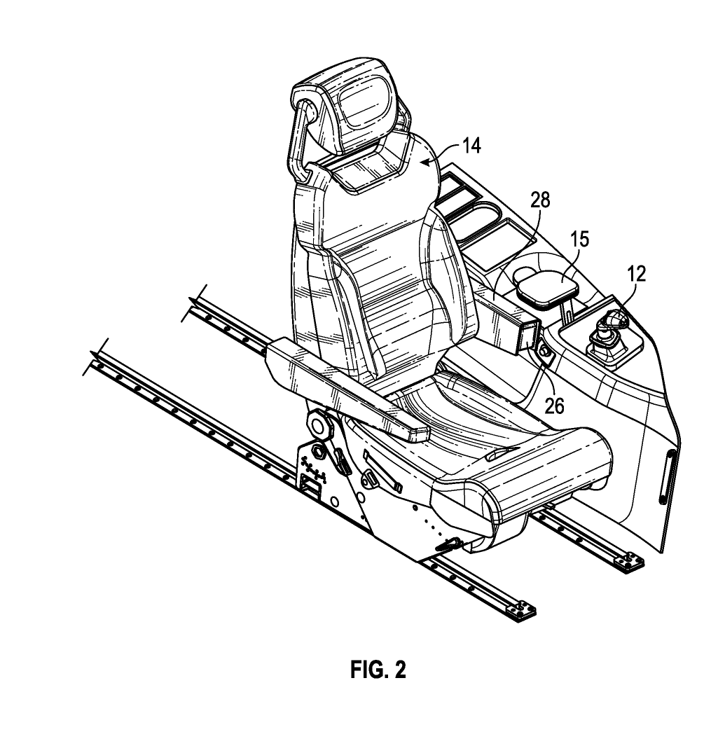

Further illustrated in FIG. 1 is an embodiment of an aircrew seat 14 mounted in flight deck 10 on a pair of rails 16. Aircrew seat 14 may be moved between an ingress/egress position and a flying position. The ingress/egress position, which is illustrated in FIG. 1, is spaced apart in an aft direction from the instrument panel (not shown) at the front of flight deck 10 in order to permit an aircrew member to enter or exit aircrew seat 14. When aircrew seat 14 is in the flying position (see FIG. 2), aircrew seat 14 is positioned much closer to the front of flight deck 10 and to the instrument panel (not shown) in order to permit an aircrew member to reach/access the various flight control actuators.

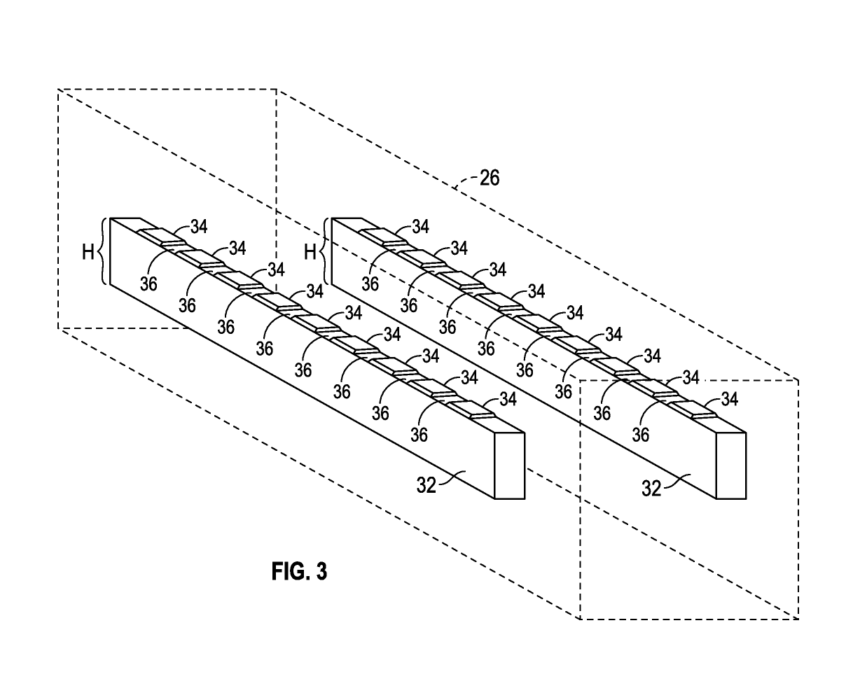

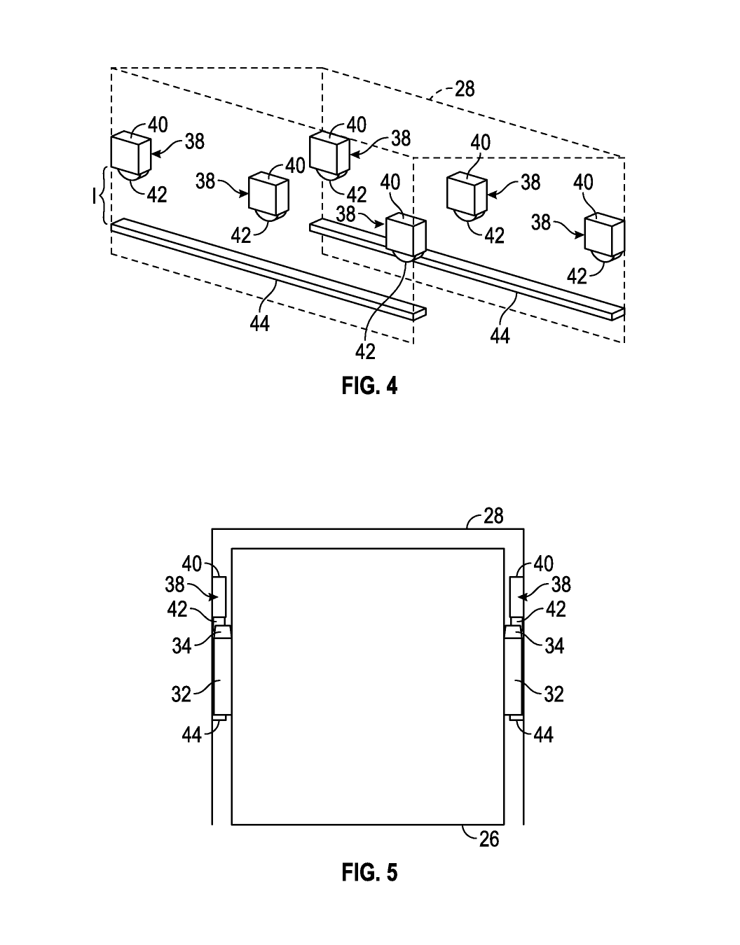

Aircrew seat 14 includes a seat bottom 18, a seat back 20, an inboard armrest 22, and an outboard armrest 24. Outboard armrest 24 includes an inner section 26 directly mounted to seat back 20 and an outer section 28 telescopically coupled with inner section 26. The telescopic coupling between inner section 26 and outer section 28 permits outer section 28 to translate along inner section 26. As best illustrated in FIGS. 3-5, outer section 28 is configured to slide on rails mounted to inner section 26. Assembled in this manner, outer section 28 is able to move back and forth between an extended position (illustrated in FIG. 1) and a retracted position (illustrated in FIG. 2).

In the illustrated embodiment, outer section 28 has a U-shaped channel configuration and inner section 26 has an elongated three dimensional box configuration that fits within the hollow portion of outer section 28. In other embodiments, any other configuration that permits outer section 28 to extend/retract with respect to inner section 26 may also be employed without departing from the teachings of the present disclosure.

Aircrew seat 14 further includes a pair of rail supports 30. Pair of rail supports 30 mount seat bottom 18 to pair of rails 16 and are configured for sliding engagement with pair of rails 16. In addition, in some embodiments, pair of rail supports 30 are configured to extend and retract, permitting an aircrew member to adjust the elevation of seat bottom 18, seat back 20, inboard armrest 22 and outboard armrest 24. This may be helpful to permit an aircrew member to adjust the height of aircrew seat 14 to accommodate that aircrew member's individual dimensions.

In the illustrated embodiment, aircrew seat 14 moves between the ingress/egress position and the flying position along pair of rails 16. The extent to which aircrew seat 14 is moved forward when in the flying position will depend upon the height of the aircrew member. If aircrew seat 14 is adjusted to a height where outboard armrest 24 is positioned below an upper surface of port side console 13 and if aircrew seat 14 is moved sufficiently forward, outboard armrest 24 will encounter port side console 13. Alternatively, if the height of aircrew seat 14 is adjusted to a position that places outboard armrest 24 above an upper surface of port side console 13, then when aircrew seat 14 is moved forward, it may encounter either stationary armrest 15 or side stick controller 12. In any event, when aircrew seat 14 is moved from the ingress/egress position towards the flying position, if outer section 28 makes contact with either port side console 13 or with stationary armrest 15 or with side stick controller 12, or with any other stationary component on flight deck 10, outer section 28 will move towards a retracted position in response to such contact. This is best illustrated in FIG. 2.

In FIG. 2, aircrew seat 14 has been moved to a flying position. Outboard armrest 24 made contact with a wall of port side console 13 as aircrew seat 14 moved to the flying position. In response to this contact, outer section 28 telescopically collapsed over inner section 26 and retracted away from the wall. The same result would have occurred had aircrew seat 14 been adjusted to a higher position, causing outer section 28 to make contact with either stationary armrest 15 or side stick controller 12. In particular, the coupling between outer section 28 and inner section 26 is calibrated to retain outer section 28 in the extended position until an aft directed force is exerted on outer section 28. If the aft directed force exceeds a predetermined threshold, outer section 28 will move aft and retract over inner section 26. The predetermined threshold is calibrated so as to be lower than the amount of force needed to provide an input into side stick controller 12. This arrangement ensures that, if outer section 28 encounters side stick controller 12 as aircrew seat 14 is moved forward, then outer section 28 will not provide any input into side stick controller 12.

FIG. 3 is a perspective view illustrating inner section 26. Portions of inner section 26 have been illustrated in phantom to allow a closer examination of the mechanism that permits movement between inner section 26 and outer section 28. As illustrated, inner section 26 includes a pair of rails 32 mounted to an external surface of the vertical walls of inner section 26. With continuing reference to FIGS. 1-2, pair of rails 32 provides a platform that supports outer section 28 and that guides the movement of outer section 28 as outer section 28 moves back and forth with respect to inner section 26. As will be discussed below, outer section 28 has a plurality of bearings that are configured to engage pair of rails 32 to facilitate movement of outer section 28 with respect to inner section 26.

Each rail of pair of rails 32 has a height H. Each rail of pair of rails 32 includes a plurality of raised surfaces 34 and a corresponding plurality of depressed surfaces 36. In the illustrated embodiment, each raise surface 34 resides between two adjacent depressed surfaces 36 to form a series of plateaus and valleys. This series of plateaus and valleys form a plurality of discrete detent positions that resist the sliding movement between inner section 26 and outer section 28. The bearings mounted on outer section 28 are configured to engage the valleys (detent positions). The bearings reside in the detent positons and offer some amount of resistance to movement over the plateaus. This engagement between the bearings of outer section 28 and the detent positions of inner section 26 permits an aircrew member to manually adjust outer section 28. When an aircrew member pulls outer section 28 in an outward direction to a desired location or pushes outer section 28 in an inward direction to a desired location, the engagement between the bearings of outer section 28 and the detent positions of inner section 26 cause outer section 28 to remain in that position. Outer section 28 will remain in that position with respect to inner section 26 until a force is exerted on outer section 28 that overcomes the resistance offered by plurality of raised surfaces 34. The curvature and/or the height of the walls of plurality of raised surfaces 34 will play a role in determining the amount of force that is needed to move outer section 28 with respect to inner section 26—the steeper the walls and/or the higher the walls, the greater will be the amount of force needed to move outer section 28 from a given detent position.

With continuing reference to FIGS. 1-3, FIG. 4 is a perspective view illustrating outer section 28. Portions of outer section 28 have been illustrated in phantom to permit a closer examination of the mechanism that permits movement between outer section 28 and inner section 26. As illustrated, a plurality of bearings 38 are mounted to an internal portion of the vertical walls of outer section 28. Each bearing includes a housing 40 and a wheel 42. Each wheel 42 is mounted in housing 40 in a manner that permits wheel 42 to spin. Additionally, each housing 40 is configured to urge each wheel 42 in a downward direction. This may be accomplished through the use of springs, spongy material, elastic, or in any other suitable manner known to those of ordinary skill in the art. A pair of retaining rails 44 are attached to the inside portions of the vertical walls of outer section 28 at a location below plurality of bearings 38. Each rail of pair of retaining rails 44 engages an underside of each respective rail of pair of rails 32. Each rail of pair of retaining rails 44 is spaced apart from a lower surface of housing 40 by a distance I. Distance I is greater than the height H of each rail of pair of rails 32. This permits outer section 28 to be mounted onto inner section 26 with pair of rails 32 being received in a gap between housings 40 and pair of retaining rail 44. In some embodiments, distance I will only slightly exceed height H in order to compress wheels 42 in their respective housings 40. This arrangement provides a robust engagement between wheels 42 and the detent positions of pair of rails 32.

With continuing reference to FIGS. 1-4, FIG. 5 is an axial view illustrating engagement between inner section 26 and outer section 28. In this view, the nested relationship between inner section 26 and outer section 28 can be observed. Also visible is the engagement between pair of rails 32, on the one hand, and bearings 38 and retaining rails 44, on the other hand. Wheels 42 are partially obscured by raised surfaces 34 because wheels 42 are resting against depressed surfaces 36 between two adjacent raised surfaces 34.

Although FIGS. 3-5 depict the use of plurality of raised surfaces 34 and plurality of depressed surfaces 36 and plurality of bearings 38 to provide a sliding engagement with detent positions, it should be understood that a wide variety of alternative mechanisms exist for providing a plurality of detent positions. It should be understood that any alternative mechanism may used in conjunction with the teachings disclosed herein and nothing presented herein should be construed as limiting the present disclosure to use of the mechanisms and arrangements described and illustrated herein.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircrew seat for use in a flight deck, the aircrew seat comprising:
a seat assembly including a seat back, the seat assembly configured to be mounted in the flight deck; and
an armrest mounted to a side of the seat back, an end of the armrest configured to move fore and aft between an extended position and a retracted position.

2. The aircrew seat of claim 1, wherein the armrest comprises a first section and a second section, the first section being coupled to the seat back and the second section being coupled to the first section.

3. The aircrew seat of claim 2, wherein the second section is configured to translate with respect to the first section.

4. The aircrew seat of claim 2, wherein the second section is coupled to the first section in a telescoping manner.

5. The aircrew seat of claim 4, wherein the second section comprises a U-shaped channel, and wherein the first section is received within a hollow portion of the second section.

6. The aircrew seat of claim 4, wherein the second section is coupled to the first section via a rail and wherein the second section slides along the rail with respect to the first section.

7. The aircrew seat of claim 6, wherein the second section is coupled to the first section via a plurality of the rails.

8. The aircrew seat of claim 6, wherein the rail includes a plurality of detents and wherein one of the first section and the second section is configured to releasably engage each detent of the plurality of detents.

9. The aircrew seat of claim 1, wherein the end of the armrest is configured to move aft towards the retracted position in response to an aft directed push applied to the end of the armrest.

10. The aircrew seat of claim 9, wherein the end of the armrest is configured to move aft towards the retracted position in response to a push is imparted by an aircrew member.

11. The aircrew seat of claim 9, wherein the end of the armrest is configured to move aft towards the retracted position in response to a push is imparted by any flight deck component encountered by the end of the armrest as the seat assembly moves in a forward direction through the flight deck.

12. An aircrew seat for use in a flight deck, the aircrew seat comprising:
a seat assembly including a seat back, the seat assembly configured to be mounted in the flight deck proximate a side stick controller; and
an armrest mounted to a side of the seat back proximate the side stick controller, the armrest comprising a first section and a second section, the first section coupled to the seat back, the second section telescopically coupled to the first section, the second section configured to move fore and aft between an extended position and a retracted position, the second section further configured to move aft toward the retracted position in response to an aft directed push applied to the second section.

13. The aircrew seat of claim 12, wherein the second section comprises a U-shaped channel, and wherein the first section is received within a hollow portion of the second section.

14. The aircrew seat of claim 12, wherein the second section is coupled to the first section via a rail and wherein the second section slides along the rail with respect to the first section.

15. The aircrew seat of claim 14, wherein the second section is coupled to the first section via a plurality of the rails.

16. The aircrew seat of claim 14, wherein the rail includes a plurality of detents and wherein one of the first section and the second section is configured to releasably engage each detent of the plurality of detents.

17. The aircrew seat of claim 12, wherein the second section is configured to move aft towards the retracted position in response to a push is imparted by an aircrew member.

18. The aircrew seat of claim 12, wherein the second section is configured to move aft towards the retracted position in response to a push is imparted by any flight deck component encountered by the second section as the seat assembly moves in a forward direction through the flight deck.

19. The aircrew seat of claim 18, wherein the second section is configured to move aft towards the retracted position in response to a push imparted by the side stick controller when the side stick controller is encountered by the second section as the seat assembly moves in the forward direction through the flight deck.
